(19) United States
(12) Patent Application Publication
(10) Pub. No.: US 2016/0203689 A1
(43) Pub. Date: Jul. 14, 2016

(54) Object Displacement Detector

(71) Applicants: Kenneth J. Hintz, Fairfax Station, VA (US); David G. Grossman, Vienna, VA (US)

(72) Inventors: Kenneth J. Hintz, Fairfax Station, VA (US); David G. Grossman, Vienna, VA (US)

(21) Appl. No.: 14/988,355

(22) Filed: Jan. 5, 2016

Related U.S. Application Data
(60) Provisional application No. 62/100,927, filed on Jan. 8, 2015.

(51) Int. Cl. G08B 13/196

(52) U.S. Cl. CPC G08B 13/19608; G08B 13/19695

(57) ABSTRACT

A motion sensor comprises sensor(s), focus analyzer(s) and displacement processor(s). The sensor(s) may be configured to acquire at least one set of spatiotemporal measurements of at least two distinct focus zones. The focus analyzer(s) may be configured to process the spatiotemporal measurements set(s) to determine an in-focus status of distinct focus zone(s). The displacement processor(s) may be configured to generate object displacement vector(s), based at least in part, on a sequence of in-focus status indicative of object(s) moving between at least two of the distinct focus zones. An alert module may be employed to activate an alert in response to displacement vector(s) exceeding a threshold.

### CROSS-REFERENCE TO RELATED APPLICATIONS

This application claims the benefit of U.S. Provisional Application No. 62/100,927, filed Jan. 8, 2015, which is hereby incorporated by reference in its entirety.

### BRIEF DESCRIPTION OF THE SEVERAL VIEWS OF THE DRAWINGS

The accompanying drawings, which are incorporated in and form a part of the specification, illustrate an embodiment of the present invention and, together with the description, serve to explain the principles of the invention.

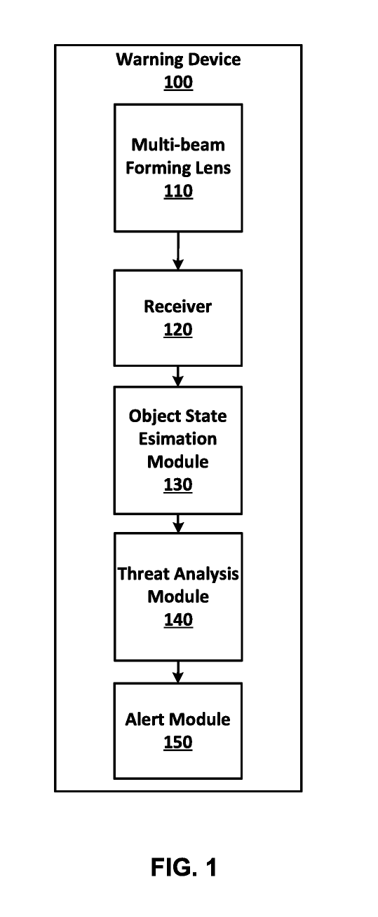

Example FIG. 1 is a block diagram illustrating a personal warning device according to various aspects of an embodiment.

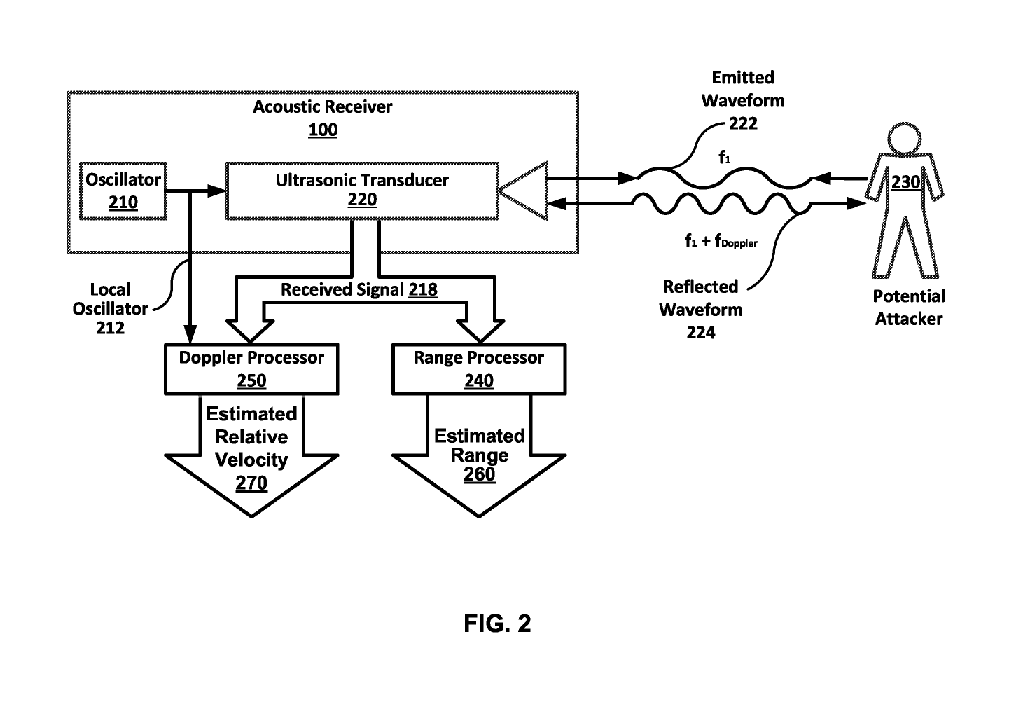

Example FIG. 2 is a block diagram illustrating an acoustic personal warning device according to various aspects of an embodiment.

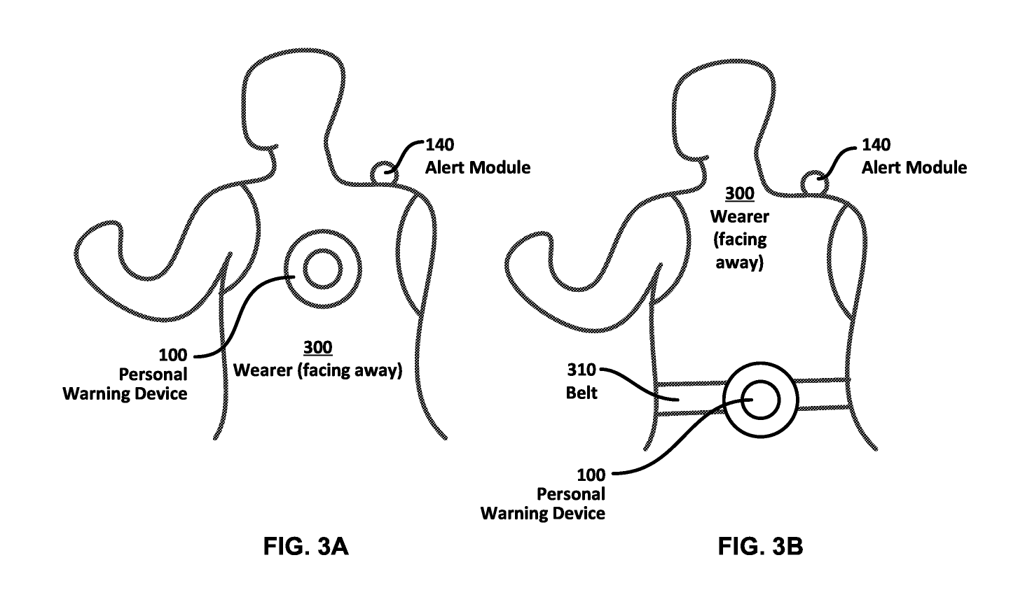

Example FIG. 3A and FIG. 3B are is a diagrams showing [[a]] rear view embodiments of a personal warning device mounted upon a user's back according to various aspects of an embodiment.

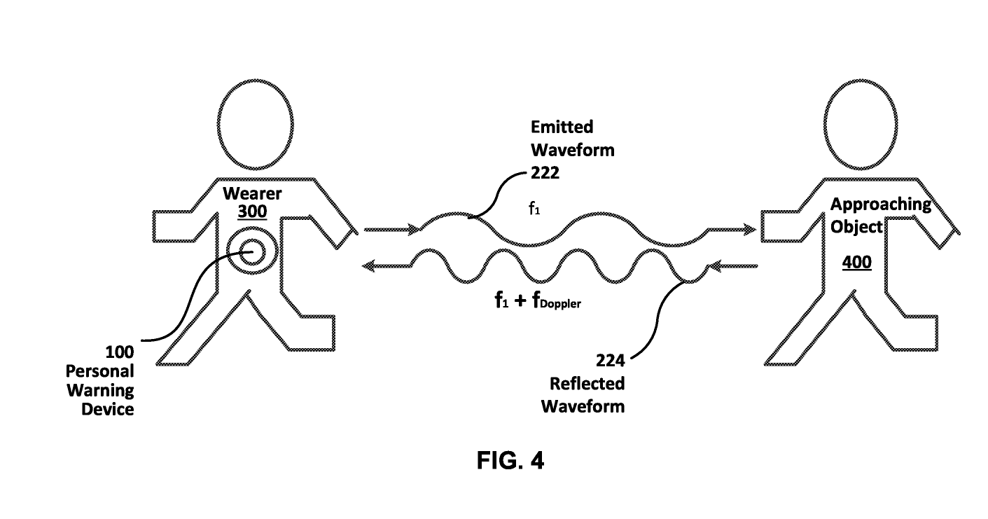

Example FIG. 4 is a diagram showing a side view of a personal warning device with an acoustic sensor mounted upon a user's back according to various aspects of an embodiment.

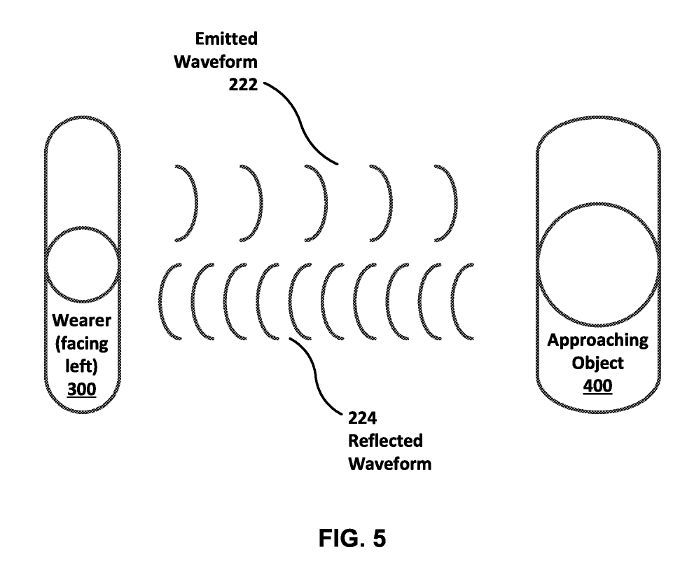

Example FIG. 5 is a diagram showing a top view of an embodiment of a personal warning device with an acoustic sensor mounted upon a user's back according to various aspects of an embodiment.

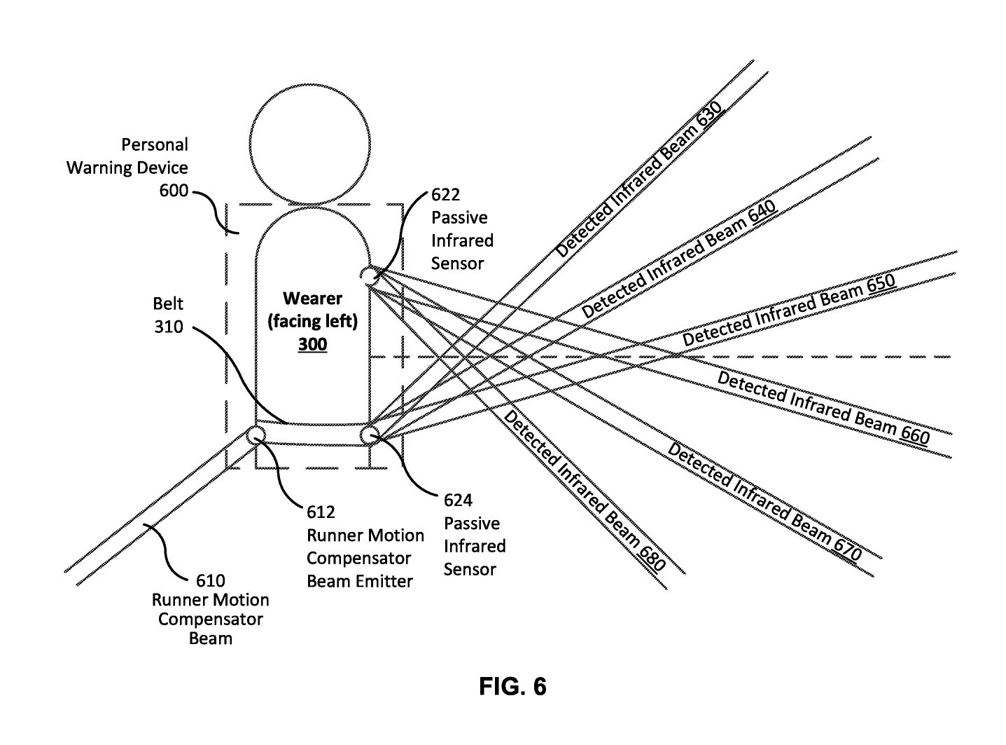

Example FIG. 6 is a diagram showing a side view of a personal warning device with multiple passive infrared sensors and a runner motion compensator beam mounted upon a runner according to various aspects of an embodiment.

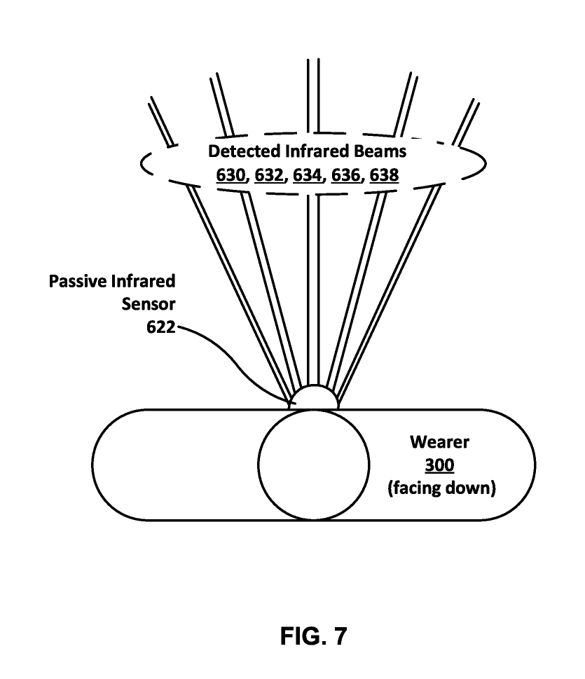

Example FIG. 7 is a diagram showing a top view of a personal warning device with a passive infrared sensor mounted upon a user's back according to various aspects of an embodiment.

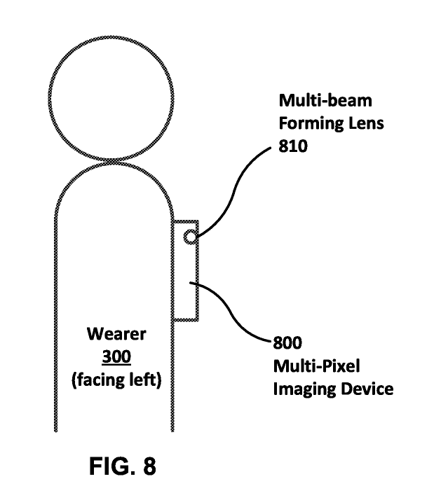

Example FIG. 8 is a diagram showing a side view of a personal warning device with an imaging sensor mounted upon a user's back according to various aspects of an embodiment.

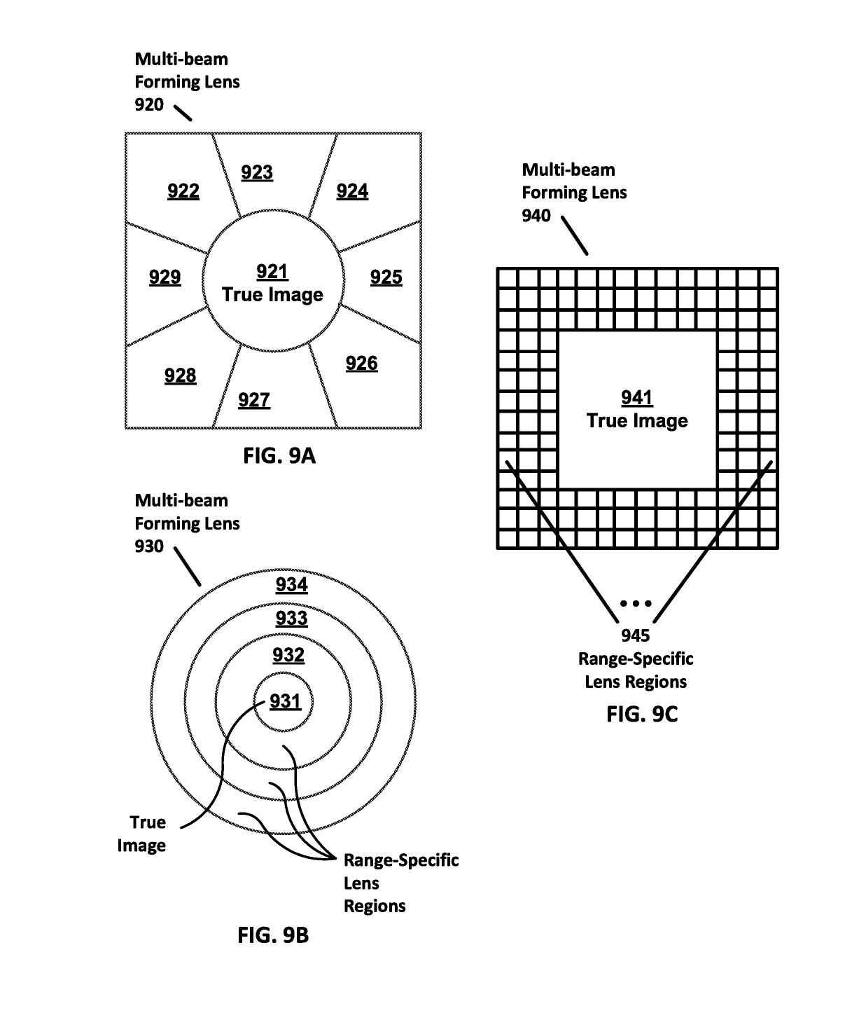

Example FIG. 9A, FIG. 9B, and FIG. 9C show multi-beam forming lenses according to various aspects of an embodiment.

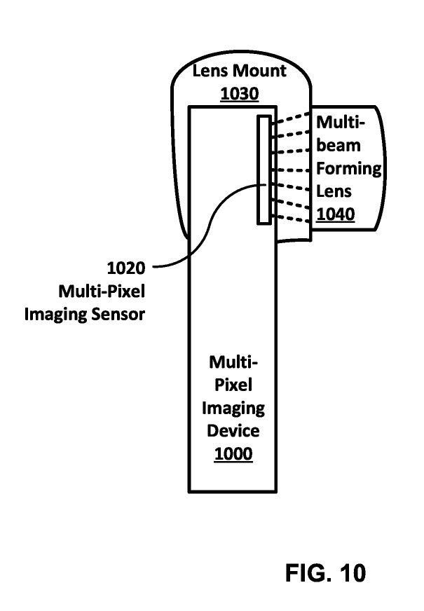

Example FIG. 10 shows a side view of a personal warning device with an imaging sensor that is mounted upon a user's back according to various aspects of an embodiment.

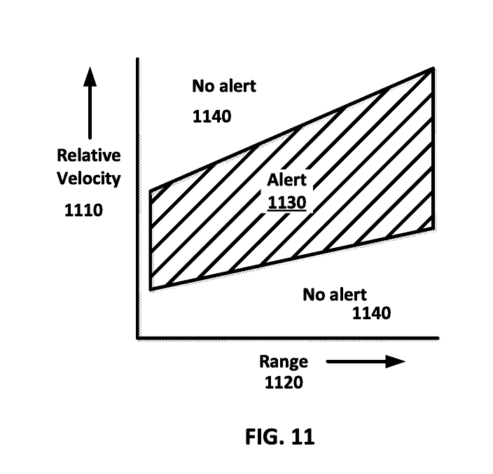

Example FIG. 11 shows an example embodiment of alert parameters according to various aspects of an embodiment.

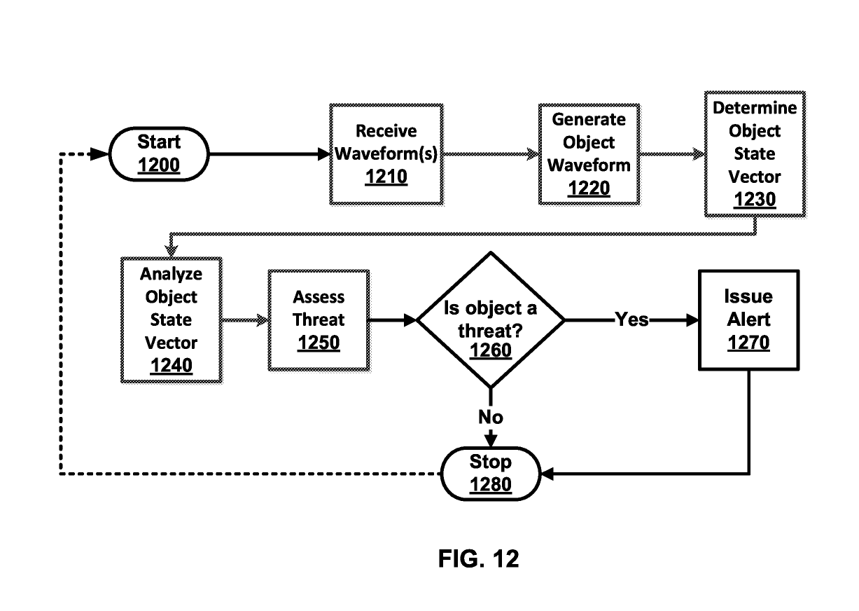

Example FIG. 12 shows an example process for warning according to various aspects of an embodiment.

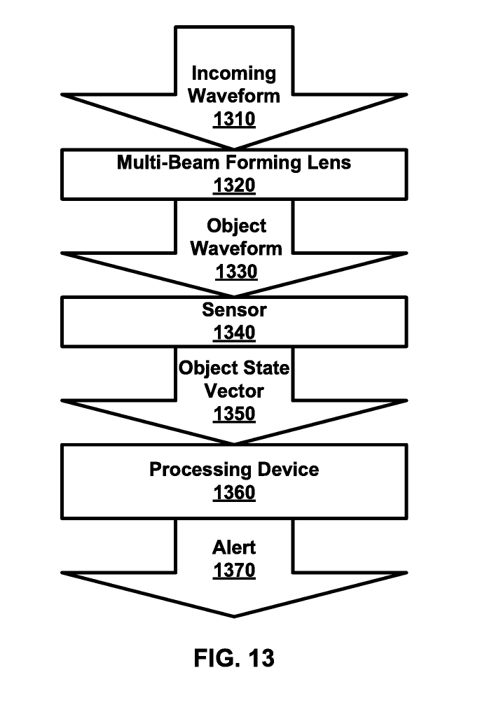

Example FIG. 13 shows an example method of warning according to various aspects of an embodiment.

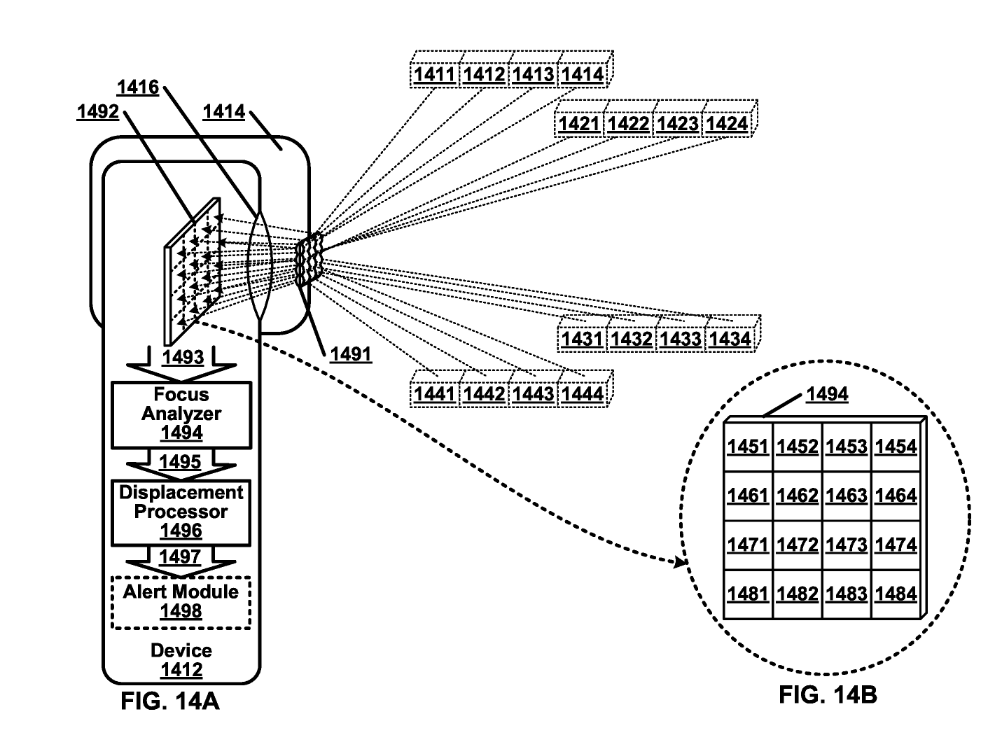

Example FIG. 14A and FIG. 14B is an illustration of illustrate an example motion detection apparatus according to various aspects of an embodiment.

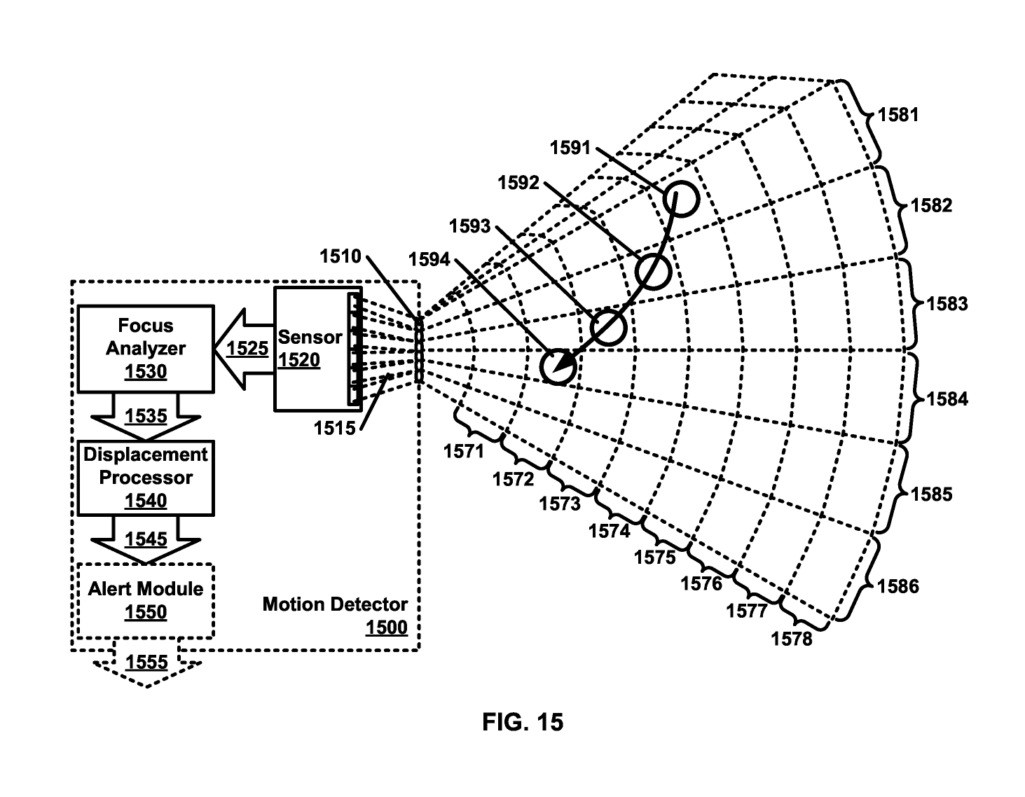

Example FIG. 15 is a diagram illustrating a motion detector detecting an object at various times as it passes through a series of spatial zones according to an embodiment.

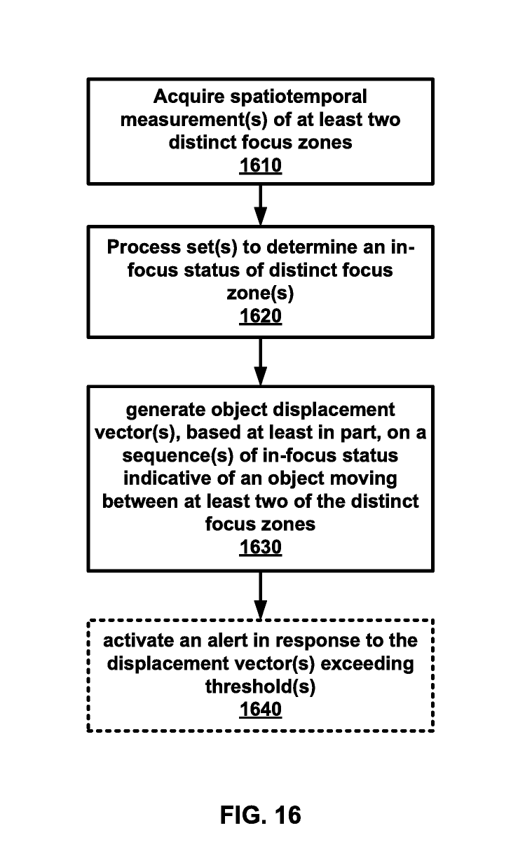

Example FIG. 16 is a flow diagram of motion detection according to various aspects of an embodiment.

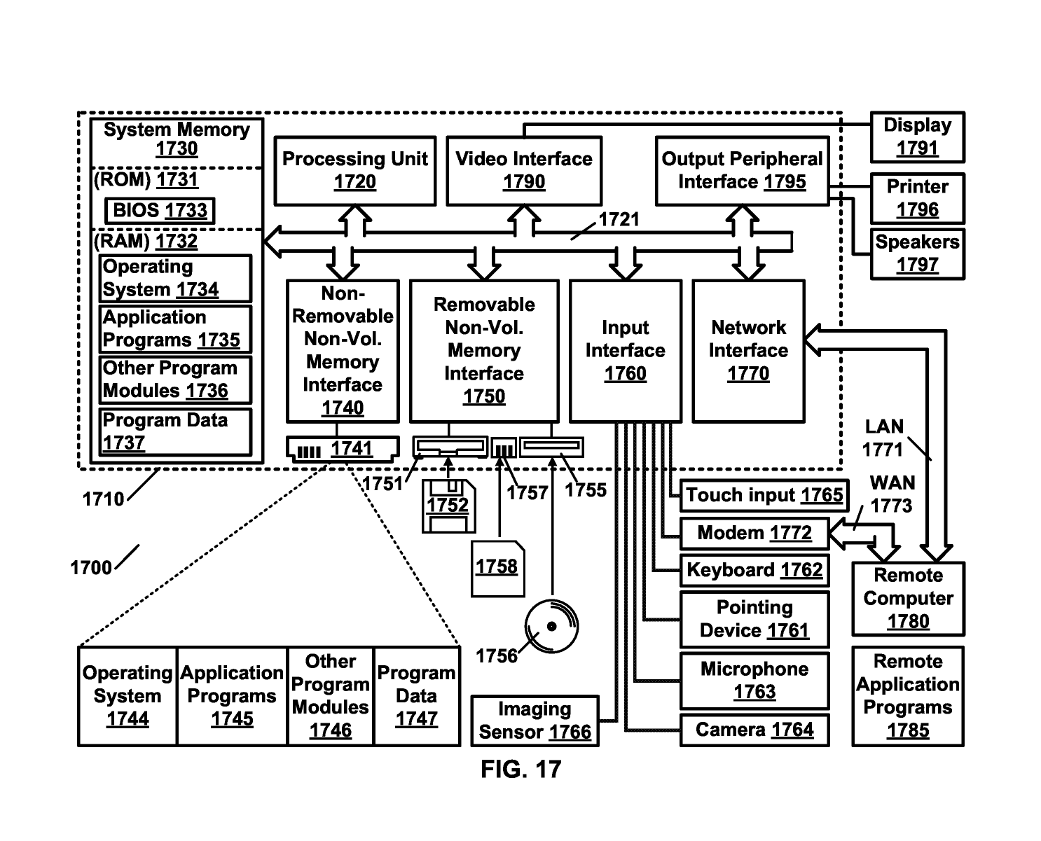

Example FIG. 17 illustrates an example of a computing system environment on which aspects of some embodiments may be implemented.

### DETAILED DESCRIPTION OF EMBODIMENTS

Embodiments of the present invention comprise a personal warning device including a multi-beam forming lens, a receiver, an object state estimation module, a threat analysis module, and an alert module. A personal warning device may be employed to warn a user of an approaching object that they may not otherwise see. According to some of the various embodiments, the warning may be via an emitted alert. Emitted alerts may be comprised of human sensible or device sensible emissions. Embodiments may be configured to detect objects comprising, but not limited to: person(s), car(s), animal(s), potential attacker(s), intruder(s), combinations thereof, and/or the like. The multi-beam forming lens may form multiple beams focused on different spatial zones in the environment in order for each of those beams to allow the personal warning device to detect objects in each of those spatial zones. The receiver may be configured to receive a variety of types of signals, comprising, but not limited to: infrared signals, ultraviolet signals, visual signals, sonar signals, optical imaging signals, electromagnetic signals, combinations thereof, and/or the like. The object state estimation module may be configured to analyze incoming object waveforms reflected from object(s) in a field of view of the personal warning device or radiated by object(s) in the field of view. The threat analysis module may be configured to produce a threat assessment by determining if an object's state vector is within at least one threat detection envelope. The alert module may be configured to issue one or more of a variety of alerts if an object is within a threat region of a multivariable function. Examples of human sensible emitted alerts may comprise, but are not limited to: audible sounds, subsonic vibrations, lights, electric shocks, and activated recordings combinations thereof, and/or the like. Device sensible emitted alerts may comprise, but are not limited to automatically transmitted messages, coded signals, combinations thereof, and/or the like transmitted by wire or wirelessly to a communications device or a secondary alerting device.

Some of the various embodiments may be configured to allow individuals to be alerted to unexpected potential threats approaching them from, for example, outside their field of view. Similarly, some of the various embodiments may be configured to alert a user of intruders in a particular area. A personal warning device may have a mounting means for mounting at least part of the personal warning device on a user's back, arm, harness, belt, or other form of attachment. Some of the various embodiments may comprise a mounting means to mount the personal warning device 100 on a wearable safety vest as illustrated in example FIG. 3. Such a safety vest may further comprise a belt 310 to stabilize the vest and the personal warning device 100. A safety vest according to some of the various embodiments that may be employed as a mounting means for a personal warning device may be acquired, for example, from ML Kishigo, of Santa Ana, Calif. A personal warning device may be mounted on other parts of a user's body as well, such as an arm, leg, or neck band. Additionally, according to some of the various embodiments, a safety vest may comprise an external alert module 140. The external alert module may be configured to emit an alert if an object produces signals within an object detection threshold. Examples of alerts may comprise, but are not limited to: sounds, lights, electric shocks, activated recordings, automatically transmitted messages, combinations thereof, and/or the like.

According to some of the various embodiments, a personal warning device 100 may comprise a multi-beam forming lens 110, a receiver 120, an object state estimation module 130, a threat analysis module 140, and an alert module 150 as illustrated in example FIG. 1.

The multi-beam forming lens 110 may be made out of a variety of materials, including glass, plastic, dielectric materials, combinations thereof, and/or the like. The multi-beam forming lens 110 may form multiple beams focused on different zones. The zones may comprise different ranges, azimuths, elevations, orientations, segments, spatial regions, combinations thereof, and/or the like. Forming multiple beams focused on different zones may be configured to enable the warning device to detect objects at various angles around the user. Forming multiple beams focused on different zones (e.g., as specified by azimuth, elevation, and range) may also enable the warning device to process the movement of objects between zones. Depending on the type of input that the sensor is configured to sense, a multi-beam forming lens may comprise, but not be limited to, one or more of: a refractive lens, a reflective lens, a Fresnel imaging lens, a dielectric lens, an optical lens, a reflective lens, a plurality of lenses, a hyperspectral lens, a combination thereof, and/or the like. Lenses may be designed to effectively utilize sonic or ultrasonic frequencies as well as electromagnetic radio frequencies.

As illustrated in example FIG. 9A, FIG. 9B and FIG. 9C, a multi-beam forming lens 920, 930, 940 may be divided into range-specific lens regions (e.g., 922-929, 932-934 and 945 respectively) and may feature a “true image” region (e.g., 921, 931 and 941 respectively). A “true image” region may be an image of one or more zones that is not substantially distorted or adjusted. This “true image” region 921 may be viewed to see an image of what is occurring in a sensor's field of view. This imaging capability can be used to reduce the communications bandwidth associated with a region monitoring system covered by the device. For example, according to some embodiments, the device may operate in first mode where only detections and/or alerts are communicated. If a monitoring agent then wants to acquire additional information about the detection and/or alert, all or part of the true image region may be communicated to provide additional data. This additional information may be employed to make a judgement about the source of the detection and/or alert.

The segments may be arranged in a variety of patterns, such as a grid, concentric circles, other patterns, a combination thereof, and/or the like. Some example of patterns are shown in examples 920, 930, 940 of FIG. 9A, FIG. 9B and FIG. 9C respectively.

The object state estimation module 130 may be configured to analyze the object waveforms received by the receiver to determine at least one object state vector for objects in a field of view of the personal warning device. An object state vector may comprise a variety of data such as, but not limited to the object's: velocity, range, distance, acceleration, relative velocity components, total relative velocity, relative range, relative acceleration components, total relative acceleration, relative distance, a combination thereof, and/or the like. A data entry within an object state vector may be determined based upon a comparison between an object's current state and one or more previous states of the object. An object state vector may be comprised of information derived, at least in part, from one or more temporally separated object waveforms. The selection of data entries within an object state vector may depend upon, for example, the type of sensor employed or the threat detection envelope parameters employed to determine if an object may be a threat. An object state estimation module may analyze when an object crosses a sequence of multiple zones when determining an object's object state vector.

It is envisioned that multiple mechanisms may be employed to determine when an object crosses a sequence of multiple zones such as, for example, a finite state machine (FSM) which can be designed to detect a specific sequence of events in the same manner as an FSM can be used to detect words (strings of symbols) in a regular language. A finite state machine is in only one of a finite set of states at a time. The state it is in at any given time is called the present state. The FSM may change from one state to another when initiated by a triggering event or condition; this is called a transition. A particular FSM may be defined, at least in part, by a list of available states and transitions, as well as triggering condition(s) for each transition. Formally, an FSM is a quintuple of sets, M=(S, I, O, δ, β), where S is the finite set of states, I is the finite set of input symbols, O is the finite set of output symbols, δ is the finite set of state transitions, and β is the finite set of output functions.

The threat analysis module 140 may be configured to produce a threat assessment by determining if at least one object state vector estimated by the object state estimation module falls within at least one threat detection envelope 1130. A threat detection envelope may include a minimum range, a maximum range, a minimum acceleration, a minimum velocity, a multi-dimensional feature space, a combination thereof, and/or the like. An example threat detection envelopes are shown in FIG. 11. The specific selection of threat detection envelope parameters may depend upon the type of sensor that the receiver employs and upon the specific usage of the personal warning device. A threat assessment may comprise a score or rating indicating how many threat detection envelopes the object state vector falls within. A threat assessment may be weighted such that certain threat detection envelopes may be more influential in determining the threat level than others. The threat analysis module may be configured to allow a user to customize the selection and magnitude of the threat detection envelope parameters essentially setting its operational sensitivity to threats.

The alert module 150 may be configured to issue an alert if the threat assessment determined by the threat analysis module exceeds a threshold. The threat assessment with respect to individual threat detection envelopes or the total threat assessment of multiple threat detection envelopes as shown in FIG. 11 may determine whether the threat assessment exceeds a threshold necessary to issue an alert. The alert module may be configured to issue a variety of alerts, including illuminating a light, activating a recorder, generating a tactile vibration, sending a wireless message, generating an audible sound, a combination thereof, and/or the like. A wireless message or recording may be sent to a predetermined contact, such as, but not limited to an emergency contact or to police. The alert may also activate a variety of other defensive actions, including a light, a wireless message, a sound, a recorder, a pre-recorder, a chemical spray device, an electric shock device, a combination thereof, and/or the like. The alert module may be interfaced with a mobile phone, tablet, or other communication device to customize the nature of the alert or to act as a transmitter for the alert. The alert module may also be triggered by an alternative trigger means, such as a panic button or dead-man's switch.

Variations in Sensing

The receiver 140 may comprise one or more of a variety of sensors, including an imaging sensor, a video imaging sensor, an acoustic sensor, an ultrasonic sensor, a thermal imaging sensor, an electromagnetic sensor, an array of sensors, a combination thereof, and/or the like. An imaging sensor may comprise a sensor that detects and conveys information that constitutes an image. An imaging sensor may convert the variable attenuation of waves (as they pass through or reflect off objects) into signals that convey the information. The waves may be light or other electromagnetic radiation. Image sensors may be used in electronic imaging devices of both analog and digital types, which may comprise, but are not limited to: digital cameras, camera modules, medical imaging equipment, night vision equipment such as thermal imaging devices or photomultipliers, radar, sonar, and/or the like. An imaging sensor may comprise, for example, a semiconductor charge-coupled device (CCD), an active pixel sensor in complementary metal-oxide-semiconductor (CMOS) or N-type metal-oxide-semiconductor (NMOS, Live MOS) technologies, a combination thereof, and/or the like. A video imaging sensor may comprise one or more imaging sensors configured to transmit one or more image signals as video. Such imaging sensors may be acquired, for example, from ON Semiconductor of Phoenix, Ariz.

An acoustic sensor may comprise a microelectromechanical systems (MEMS) device that, for example, detects the modulation of surface acoustic waves to sense a physical phenomenon. The sensor may transduce an input electrical signal into a mechanical wave which, unlike an electrical signal, may be influenced by physical phenomena. The device may transduce such a mechanical wave back into an electrical signal. Changes in amplitude, phase, frequency, or time-delay between the input and output electrical signals may be employed to measure the presence of phenomena. An acoustic sensor may be acquired, for example, from Interlogix, of Lincolnton, N.C..

For a personal warning device 100 where the receiver is an acoustic sensor, the personal warning device 100 may further include an outgoing waveform transmitter 220, such as an ultrasonic transducer, as shown in the example embodiment of FIG. 2. An ultrasonic sensor may comprise a transducer that converts ultrasound waves to electrical signals or vice versa. An ultrasonic sensor that both transmits and receives may be called an ultrasound transceiver. Some ultrasonic sensors besides being sensors may be transceivers because they may both sense and transmit. Ultrasonic detection device(s) and/or system(s) may evaluate, at least in part, attributes of a target by interpreting echoes from radio and/or sound waves. Some of the various active ultrasonic sensors may generate high frequency sound waves, evaluate the sound wave received back by the sensor, and measure the time interval between sending the signal and receiving the echo to determine the distance to an object. Passive ultrasonic sensors may comprise microphones configured to detect ultrasonic waves present under certain conditions, convert the waves to an electrical signal, and report the electrical signal to a device. Various ultrasonic sensor(s) may be acquired, for example, from Maxbotix, of Brainerd, Minn., or from Blatek, Inc. of State College, Pa.

A personal warning device, according to some of the various embodiments, may further comprise a local oscillator 210, and an object waveform analyzed by the object state estimation module may comprise two or more temporally separated incoming waveforms 224. This may involve comparing the frequency of an emitted waveform 222 which may be generated from the local oscillator 210 to that of an incoming waveform 224 reflected off of an object 230 and performing a Doppler shift calculation. This comparison may allow the object state estimation module to estimate the relative velocity of the object with respect to the personal warning device. The incoming waveforms may be modulated waveforms, pulsed waveforms, chirped waveforms, linear swept waveforms, or frequency modulated continuous waveforms or any of a number of other waveforms appropriate to the type of processing desired.

A personal warning device 600, as shown in the example embodiment of FIG. 6, may comprise a receiver comprising two or more passive infrared sensors 622 and 624. A passive infrared sensor (PR) may measure infrared (IR) light radiating or reflected from objects in a field of view. PIR sensor(s) may be employed in PR-based motion detectors. The term passive in this instance refers to the fact that PR devices do not generate or radiate any energy for detection purposes. A passive PIR sensor may work by detecting the energy given off by other objects. PIR sensors may not detect or measure “heat,” but rather detect infrared radiation emitted or reflected from an object. Such a PR sensor may be acquired, for example, from Adafruit Industries, of New York City, N.Y.

According to some of the various embodiments, a personal warning device with a receiver comprising two or more passive infrared sensors 622 and 624 may further comprise a user motion compensator 610. A user motion compensator may detect a user's motion by infrared, sonar, radar, a combination thereof, and/or the like. For embodiments where the personal warning device 600 is on a moving object such as a person, bicycle, or automobile, the user motion compensator may allow the personal warning device 600 to make motion measurements.

For a personal warning device where the receiver comprises an imaging sensor, the imaging sensor may be part of the personal warning device itself, or may be a multi-pixel imaging device 800, as shown in the example embodiment of FIG. 8, that is part of, for example, a mobile phone, tablet, digital camera or other device that may be integrated into the rest of the personal warning device. In embodiments shown for example if FIG. 10 where the imaging sensor is provided by a separate multi-pixel imaging device, the multi-beam forming lens 1040 may be a lens on a fixed or removable lens mount 1030 configured to fit outside of the multi-pixel imaging device's own lens 1020 in order to provide the multi-beam forming that may be applied for certain types of detection. The personal warning device may interface with the separate multi-pixel imaging device(s) by a hard-wired connection, such as USB, VGA, component, DVI, HDMI, FireWire, combinations thereof, and/or the like. Similarly, the personal warning device may interface with the separate multi-pixel imaging device wirelessly, such as through Wi-Fi, Bluetooth, combinations thereof, and/or the like.

FIG. 14 is an illustration of an example motion detection apparatus 1412 according to various aspects of an embodiment. The apparatus may comprise: multifocal len(s) 1491, imaging sensor(s) 1492, a focus analyzer 1494, and a displacement processor 1496.

The one imaging sensor(s) 1492 may be configured to acquire at least one set of spatiotemporal measurements 1493 of at least two sensing zones (e.g. 1451, 1452, 1453, 1454, 1461, 1462, 1463, 1464, 1471, 1472, 1473, 1474, 1481, 1482, 1483, and 1484). Spatiotemporal measurements 1493 may comprise measurements that indicate optical intensities on imaging sensor(s) 1492 at distinct instances of time which are taken over periods of time. The measurements may also be integrated over shorter intervals at each of the distinct instances of time in order to improve the sensitivity of the sensing action. The electromagnetic intensities may be measured as individual values associated with individual pixels that, when spatially grouped together, provide two dimensional representations of the projection of a three dimensional image.

The imaging sensor(s) 1492 may comprise, for example, at least one of the following: an infrared imaging sensor, an ultraviolet imaging sensor, an optical imaging sensor, a camera, an electromagnetic imaging sensor, a light field device, an array of imaging sensors, combinations thereof, and/or the like. Electromagnetic imaging sensor(s) may be sensitive to visual spectrum radiation or various discrete sections of the electromagnetic spectrum such as in a hyperspectral sensor. So, as illustrated in this example embodiment, the imaging sensor(s) 1492 may comprise a camera sensor and motion detection apparatus and the device itself, 1412, may comprise mobile device hardware such as a mobile telephone. Examples of mobile devices comprise smart phones, tablets, laptop computers, smart watches, combinations thereof, and/or the like.

Sensing zones (e.g., 1451 . . . 1484) may comprise a subset of sensing areas (e.g., pixels) on the imaging sensor(s) 1492. At least one of the sensing zones (e.g., 1451 . . . 1484) may comprise a distinct region of the imaging sensor(s) 1492 which does not include the entire sensor. Although example sensing zones (e.g., 1451 . . . 1484) are illustrated as having square shapes, embodiments need not be so limited as the example sensing zones (e.g., 1451 . . . 1484) may be of various shapes such as triangular, hexagonal, rectangular, circular, combinations thereof, and/or the like. Sensing zones also may not be contiguous, but be interleaved in their projection onto the imaging sensor(s) 1492. Additionally, buffer areas may be located between sensing zones (e.g., 1451 . . . 1484). In yet another example embodiment, the image sensor(s) 1492 may comprise an array of imaging sensors with sensing zones being distributed among the array of imaging sensors.

A multifocal lens may comprise a lens that focuses multiple focal regions to discrete locations. Multi-focal lenses may comprise an array of lens, a Fresnel lens, a combination thereof, and/or the like. A multifocal lens has more than one point of focus. A bifocal lens such as is commonly used in eyeglasses, is a type of multifocal lens which has two points of focus, one at a distance and the other at a nearer distance. A multifocal lens can also be made up of an array of lenslets or regions of a single lens with different focal properties such that each region may be referred to as a lenslet. A Fresnel lens is a flat lens made of a number of concentric rings, where each concentric ring may have a different focal point or focus distance.

In this example embodiment, the multifocal len(s) 1491 may be configured to direct light from at least two of a multitude of spatial zones (e.g., 1411, 1412, 1413, 1414, 1421, 1422, 1423, 1424, 1431, 1432, 1433, 1434, 1441, 1442, 1443, and 1444) to sensing zones (e.g., 1451, 1452, 1453, 1454, 1461, 1462, 1463, 1464, 1471, 1472, 1473, 1474, 1481, 1482, 1483, and 1484). These spatial zones are determined not only by their azimuthal and elevation angular extent, but also by their range extent associated with the depth of field of the particular lenslet. So for example, an image of spatial zone 1411 may be directed to sensing zone 1451, an image of spatial zone 1412 may be directed to sensing zone 1452, an image of spatial zone 1413 may be directed to sensing zone 1453, an image of spatial zone 1414 may be directed to sensing zone 1454, an image of spatial zone 1421 may be directed to sensing zone 1461, an image of spatial zone 1422 may be directed to sensing zone 1462, an image of spatial zone 1423 may be directed to sensing zone 1463, an image of spatial zone 1424 may be directed to sensing zone 1464, an image of spatial zone 1431 may be directed to sensing zone 1471, an image of spatial zone 1432 may be directed to sensing zone 1472, an image of spatial zone 1433 may be directed to sensing zone 1473, an image of spatial zone 1434 may be directed to sensing zone 1474, an image of spatial zone 1441 may be directed to sensing zone 1481, an image of spatial zone 1442 may be directed to sensing zone 1482, an image of spatial zone 1443 may be directed to sensing zone 1483, and an image of spatial zone 1444 may be directed to sensing zone 1484. Other mappings of spatial zones to sensing zones are anticipated with various alternative embodiments.

Spatial zone(s) (e.g., 1411 . . . 1444) may comprise a defined region of space as specified by a central point in a Cartesian space (x, y, z) surrounded by an extent in each of those 3 orthogonal directions, e.g., (+/−Δx, +/−Δy, +/−Δz). An equivalent spatial zone may be defined in spherical coordinates or range, polar angle, and azimuthal angle as (ρ, θ, Φ) with the corresponding volume defining the extent of the region as, e.g., (+/−ρ, +/−Δθ, +/−ΔΦ). Spatial zones (e.g., 1411 . . . 1444) may comprise a beam comprising an instantaneous field of view and a constrained depth of field. The terms constrain, constraint, or constrained as used here means to restrict or confine the phenomenon to a particular area or volume of space. Additionally, each of the spatial zones (e.g., 1411 . . . 1444) may be azimuth, elevation and depth of field limited.

The focus analyzer 1494 may be configured to process measurement set(s) 1493 to determine in-focus status 1495 of at least two sensing zone(s) (e.g., 1451 . . . 1484). The term “status” when used in this documents may refer to either the singular or plural in accordance with the usage rules as described in the Oxford Dictionary of the English Language (OED). Focal status 1495 may comprise value(s) representing a probability of projected in-focus object(s) in a sensing zone (e.g., 1451 . . . 1484). Focal status 1495 may comprise value(s) representing a spatial percentage that projected in-focus object(s) occupy in a sensing zone (e.g., 1451 . . . 1484). Focal status 1495 may comprise a value(s) representing characteristics of projected in-focus object(s) in a sensing zone (e.g., 1451 . . . 1484). Values may be represented in analog and/or digital form. In a basic embodiment, value(s) may comprise a binary value(s) representing whether or not an in-focus projection of an object resides in a sensing zone (e.g., 1451 . . . 1484). In a more complex embodiment, value(s) may comprise a collection of values (e.g., an object state vector) that comprise various information regarding projection of object(s) in a spatial zone. Characteristics may comprise, color, texture, location, percentage of focus, shape, combinations thereof, and/or the like.

According to some of the various embodiments, the focus analyzer 1494 may be configured to determine the in-focus status 1495 of measurements 1493 employing one or more of various mechanism. For example, the focus analyzer 1494 may be configured to determine the in-focus status 1495 of measurements 1493 by applying at least one range based point spread function to at least one of the spatiotemporal measurements 1493. A point-spread function is the spatial extent of the image of a point, or equivalently, a mathematical expression giving this for a particular optical or electromagnetic imaging system. This may be performed as a deconvolution of the spatiotemporal measurements 1493. Deconvolution is normally done in the frequency (sometimes called Fourier) domain by dividing the Fourier transform of a transfer function into the Fourier transform of the received signal. This is less difficult to implement than deconvolution in the signal domain. Mathematically the two operations, deconvolution in the signal domain and division in the frequency domain, are equivalent since they form an isomorphism from one space to the other. In another example, the focus analyzer 1494 may be configured to determine at least one focus status by performing a sharpness analysis on at least one of the sensing zones (e.g., 1451 . . . 1484). Sharpness can be defined as distinctness of outline or impression. Since sharpness in an image is a measure of the rate of change of pixel values from one to the next, various techniques can be applied to determine the sharpness of an image. One method is to take the finite difference between adjacent pixels over some region and extract the largest pixel to pixel change. If this largest pixel to pixel change is above a threshold, then one would say the image is “sharp.” A second method would be to low pass and high pass the image and compute the high pass to low pass ratio of these values. A sharp image would have a larger value than a non-sharp image. A third method would be to compute the Fourier transform of the image and compare the values of the high frequency and low frequency spectral lines. A sharp image would have significant high frequency power compared to a less-sharp image. In yet another example, the focus analyzer 1494 may be configured to determine at least one focus status 1495 by performing a frequency analysis on at least one of the sensing zones. In yet other example, the focus analyzer 1494 may be configured to determine at least one focus status by performing a deconvolution of spatiotemporal measurements of at least one of the sensing zones.

According to some of the various embodiments, the focus analyzer 1494 may be configured to filter the output of the sensor to a predetermined range when determining the in-focus status. Filtering may comprise mathematical or computational operations in either the signal domain or signal frequency domain. Here we use the word signal to represent either the time or spatial domains and the phrase signal frequency to mean either temporal frequency or spatial frequency. Spatiotemporal signals may be analyzed both in the temporal and spatial frequency domains.

According to some of the various embodiments, the focus analyzer 1494 may be configured to analyze changes in measurement set 1493 comprising, but not limited to: analyzing changes in measurement values, analyzing measurement(s) 1493 for detectable edges, analyzing measurement(s) 1493 for differential values, combinations thereof, and/or the like.

The displacement processor 1496 may be configured to generate object displacement vector(s) 1497, based at least in part, on a sequence of focus status 1495 indicative of object(s) moving between at least two of the multitude of spatial zones (e.g., 1411 . . . 1444). Various mechanisms may be employed to generate object displacement vector(s) 1497. For example, displacement processor 1496 may be configured to generate the object displacement vector(s) 1497 employing sequential analysis. Sequential analysis may comprise analyzing the focus status 1495 for a multitude of sensing zones (e.g., 1411 . . . 1444) sequentially in time or space to determine if an object has passed through a multitude of spatial zone(s) (e.g., 1411 . . . 1444). The displacement processor 1496 may set object displacement vector(s) to a value (e.g., a null value) when fewer than two of the in-focus statuses each exceed at least one predetermined criterion. This null value may then indicate that a displacement vector 1497 does not exists and/or was not calculated within, for example, reliable parameters and/or reproducible values. Additionally, according to some of the various embodiments, the displacement processor 1496 may be configured to convert at least two in-focus status into at least one binary valued sequence. Such a sequence may be processed to generate object displacement vector(s), for example, employing, at least in part, a finite state machine, look-up table, or computational process to determine the movement of an object between spatial zone(s) (e.g., 1411 . . . 1444). For example, the displacement processor 1496 may be configured to generate object displacement vector(s) 1497 by comparing at least one binary valued sequence against at least one predetermined binary valued sequence. A predetermined binary sequence may be a predetermined list of binary values, or alternatively, a predetermined computational process configured to dynamically generate a binary valued sequence. According to some embodiments, the binary valued sequence may represent values other than zero and 1.

The displacement processor 1496 may be configured to generate object displacement vector(s) 1497 by analyzing, at least in part, at least two in-focus status 1495 with respect to displacement criteria. The displacement criteria may employ, at least in part, mathematical equation(s), analytic function(s), rule(s), physical principals, combinations thereof, and/or the like. For example, a displacement vector may be generated by analyzing the time and/or spatial movement of object(s) moving between spatial zones (e.g., 1411 . . . 1444) to determine displacement criteria and/or characteristics such as direction, acceleration, velocity, a collision time, an arrival location, a time of arrival, combinations thereof, and/or the like.

The multi-focal lens(es) may be configured to map light from each of a multitude of the spatial zone(s) (e.g., 1411 . . . 1444) onto at least two of the sensing zones (e.g., 1451 . . . 1484) respectively through a camera lens (e.g., 1416). The camera lens 1416 may be a mobile device camera lens 1416 as illustrated in the example embodiment of FIG. 14A. As illustrated in this example embodiment, multifocal lens 1491 may be disposed external to device 1412. An example mechanism for disposing multifocal lens 1491 external to device 1412 may comprise a clip, a bracket, a strap, an adhesive, a device case, combinations thereof, and/or the like.

Device 1412 may further comprise an alert module 1498 configured to activate an alert (or other type of notification) in response to one or more displacement vectors 1497 exceeding predetermined threshold(s). According to some of the various embodiments, at least one alert may be reported to at least one of the following: a user of the device 1412, a facility worker (when the device is used to detect motion in a facility), a tracking device, an emergency responder, a remote (non co-located) monitoring service or location, a combination of the above, and/or the like. A determination as to where an alert may be routed may be based on an alert classification. For example, a facility alert may be routed to a facility worker and/or an alarm monitoring station. A personal alarm that indicates a probability of harm to a person (e.g., a blind spot attack) may be reported to a first responder such as the police and/or the person being attacked.

Methods of notification may include, but are not limited to: email, cell phone, instant messaging, audible (sound) notification, visual notification (e.g. blinking light), combination thereof, and/or the like. Some embodiments may start with the least disturbing methods first (e.g., sounds and lights) and amplify with time until attended to. Yet other embodiments may start with an alert configured to scare away an attacker. Methods of notification may include coded alerts indicating relative or absolute location of the object of interest.

According to some of the various embodiments, the device 1412 may comprise an optical source to radiate a fluorescent inducing electromagnetic radiation configured to cause skin fluorescence. Such a source may comprise a fluorescent UV light that outputs a light comprising approximately 295 nm wavelength light. Sensor 1492 may be sensitive to this spectrum of radiation and employ the detection of such fluorescent radiation in spatial zones (e.g., 1451 . . . 1484) to discriminate between non-human objects and humans.

FIG. 15 is a diagram illustrating a motion detector 1500 detecting an object at various times (e.g., 1591, 1592, 1593 and 1594) as it passes through a series of spatial zones (e.g., volumetric zones represented by the intersecting sections of beams 1581, 1582, 1583, 1584, 1585 and 1586 with depth of field ranges 1571, 1572, 1573, 1574, 1575, 1576 and 1578) according to an embodiment. As illustrated in this example embodiment as shown in FIG. 15, motion detector 1500 comprises sensor(s) 1520, focus analyzer 1530, and displacement processor 1540.

Sensor(s) 1520 may be configured to acquire at least one set of spatiotemporal measurements 1525 of at least two distinct focus zones (e.g., volumetric zones represented by the intersecting sections of beams 1581 . . . 1586 with depth of field ranges 1571 . . . 1578). Sensor(s) 1520 may comprise at least one of the following: an active acoustic sensor, a passive acoustic sensor, a sonar sensor, an ultrasonic sensor, an infrared sensor, an imaging sensor, a camera, a passive electromagnetic sensor, an active electromagnetic sensor, a radar, a light field device, an array of sensors, a combination thereof, and/or the like.

At least one of the spatiotemporal measurement sets 1525 may be acquired employing a transducer at a fixed focus. Spatiotemporal measurements 1525 may comprise predetermined sequence(s).

The distinct focus zones (e.g., volumetric zones defined by the intersections of 1571, 1572, 1573, 1574, 1575, 1576, 1577, 1578 and 1581, 1582, 1583, 1584, 1585, 1586) may be azimuth, elevation and depth of field limited. For example, distinct spatial zones (e.g., volumetric zones defined by the intersections of 1571 . . . 1578 and 1581 . . . 1586) may comprise beam(s) comprising an instantaneous field of view and a constrained depth of field.

The focus analyzer 1530 may be configured to process each of the measurement set(s) 1525 to determine an in-focus status 1535 of at least two distinct focus zones (e.g., volumetric zones defined by the intersections of 1571 . . . 1578 and 1581 . . . 1586). The focus analyzer 1530 may be configured to determine the in-focus status 1535 by applying one or more focus determination mechanisms. For example, focus analyzer 1530 may be configured to determine the in-focus status 1535 by applying at least one point-spread function to at least one of the spatiotemporal measurement set(s). In yet another example, focus analyzer 1530 may be configured to determine at least one focus status 1535 by performing a sharpness analysis on at least one of the distinct focus zones. In yet another example, focus analyzer 1530 may be configured to determine at least one focus status 1535 by performing a frequency analysis on at least one of the distinct focus zones. In yet another example, focus analyzer 1530 is further configured to determine at least one focus status 1535 by performing a deconvolution of spatiotemporal measurements of at least one of the distinct focus zones.

The focus analyzer 1530 may be configured to filter the output of the sensor to a predetermined range when determining the in-focus status 1535.

The displacement processor 1540 may be configured to generate at least one object displacement vector 1545, based at least in part, on a sequence of in-focus status 1535 indicative of an object moving between at least two of the at least two distinct focus zones (e.g., volumetric zones defined by the intersections of (1571 . . . 1578 and 1581 . . . 1586). The displacement processor 1540 may be configured to generate the object displacement vector 1545 employing one or more displacement analysis mechanisms. For example, displacement processor 1540 may be configured to generate the object displacement vector 1545 employing sequential analysis. Displacement processor 1540 may be configured to set the object displacement vector 1545 to a null value when fewer than two of the in-focus statuses 1535 each exceed at least one predetermined criterion. Displacement processor 1540 may be configured to convert at least two in-focus status 1535 into at least one binary valued sequence. The displacement processor 1540 may be configured to generate the object displacement vector 1545 by comparing at least one binary valued sequence against at least one predetermined binary valued sequence. Displacement processor 1540 may be configured to generate the object displacement vector 1545, based at least in part, utilizing a finite state machine. Displacement processor 1540 may be configured to generate the object displacement vector 1545 by analyzing, at least in part, at least two in-focus status 1535 with respect to displacement criteria. Displacement criteria may comprise value(s) and/or ranges(s) of values. Values(s) and/or ranges of value(s) may comprise dynamically determined value(s) and/or predetermined static value(s). Examples of dynamically determined values comprise values determined employing equation(s), analytic function(s), rule(s), combinations thereof, and/or the like.

Lens(es) 1510 may be configured to map light from each of at least two of the distinct focus zones (e.g., the intersections of 1581 . . . 1586 and 1571 . . . 1578) onto a distinct region of the sensor 1520 respectively. Lens(es) 1510 may comprise a multi-focal lens configured to map light from each of at least two of the distinct focus zones (e.g., the intersections of 1581 . . . 1586 and 1571 . . . 1578) onto a distinct region of the sensor 1520 respectively. According to some of the various embodiments, the multi-focal lens may be configured to map light from each of at least two of the distinct focus zones (e.g., the intersections of 1581 . . . 1586 and 1571 . . . 1578) onto a distinct region of the sensor 1520 respectively through a camera lens. Additionally, multi-focal lens may be configured to map light from each of at least two of the distinct focus zones (e.g., the intersections of 1581 . . . 1586 and 1571 . . . 1578) onto a distinct region of the sensor 1520 on a mobile device.

The motion detector 1500 may further comprise an alert module 1550. The alert module 1550 may be configured to activate an alert 1555 in response to the displacement vector 1545 exceeding a predetermined threshold.

In yet another embodiment, a motion sensor may comprise an acoustic motion sensor. The acoustic motion sensor may comprise at least one audible or non-audible acoustic sensor, a status analyzer, and a displacement processor. The acoustic sensor(s) may be configured to acquire at least one set of spatiotemporal measurements of at least two distinct zones. The status analyzer may be configured to process each of the set(s) to determine an object presence status of at least two of distinct zones. The displacement processor may be configured to generate object displacement vector(s), based at least in part, on a sequence of object presence status indicative of an object moving between at least two of the distinct zones.

Example FIG. 16 is a flow diagram of motion detection according to various aspects of an embodiment. At least one set of spatiotemporal measurements of at least two distinct focus zones may be acquired from a sensor at 1610. The sensor may comprise at least one of the following: a passive acoustic sensor, an active acoustic sensor, a sonar sensor, an ultrasonic sensor, an infrared sensor, an imaging sensor, a camera, a passive electromagnetic sensor, an active electromagnetic sensor, a radar, a light field device, an array of homogeneous sensors, an array of heterogeneous sensors, a combination thereof, and/or the like. At least one of the at least one set of spatiotemporal measurements may be acquired employing a transducer at a fixed focus.

The spatiotemporal measurements may comprise a predetermined sequence. Each of the distinct focus zones may be azimuth, elevation and depth-of-field limited. According to some of the various embodiments, the distinct spatial zones may comprise a beam comprising an instantaneous field of view and a constrained depth of field.

The set(s) may be processed to determine an in-focus status of at least two distinct focus zones at 1620.

According to various embodiments, the in-focus status may be determined employing one or more focus determination mechanisms. For example, the in-focus status may be determined by applying at least one point-spread function to at least one of the at least one set of spatiotemporal measurements. The focus status may be determined by performing a sharpness analysis on at least one of the distinct focus zones. The at least one focus status may be determined by performing a frequency analysis on at least one of the distinct focus zones. The at least one focus status may be determined by performing a deconvolution of spatiotemporal measurements of at least one of the distinct focus zones.

The output of the sensor may be filtered to a predetermined range when determining the in-focus status.

At least one object displacement vector may be generated at 1630, based at least in part, on a sequence of in-focus status indicative of an object moving between at least two of the distinct focus zones. The object displacement vector may be determined employing at least one object vector determination mechanisms. For example, the object displacement vector may be determined employing at least one sequential analysis process. The at least one object displacement vector may produce a null value or null signal or null symbol when fewer than two of the in-focus status each exceed at least one predetermined criterion. The at least two in-focus status may be converted into at least one binary valued sequence. The object displacement vector may be generated by comparing at least one binary valued sequence against at least one predetermined binary valued sequence. The object displacement vector may be generated, based at least in part, utilizing a finite state machine. The object displacement vector may be generated by analyzing, at least in part, at least two in-focus status with respect to displacement criteria. (e.g., according to math equation, an analytic function, set of rules, combinations thereof, and/or the like.)

The method further comprises activating an alert in response to the displacement vector exceeding a threshold at 1640. (As illustrated with the dashed line indicating an optional element for alternative embodiments).

The method may further comprise: radiating a fluorescent inducing electromagnetic radiation and discriminating between objects and humans based on the detection of a fluorescent radiation from a human.

The method may further comprise mapping light from each of at least two of the distinct focus zones onto a distinct region of the sensor respectively. The method may further comprise mapping electromagnetic radiation employing a multi-focal lens from each of at least two of the distinct focus zones onto a distinct region of the sensor respectively. The method may further comprise mapping light employing a multi-focal lens from each of at least two of the distinct focus zones onto a distinct region of the sensor respectively through a camera lens. The method may further comprise mapping light employing a multi-focal lens from each of at least two of the distinct focus zones onto a distinct region of the sensor on a mobile device.

FIG. 17 illustrates an example of a suitable computing system environment 1700 on which aspects of some embodiments may be implemented. The computing system environment 1700 is only one example of a suitable computing environment and is not intended to suggest any limitation as to the scope of use or functionality of the claimed subject matter. For example, the computing environment could be an analog circuit. Neither should the computing environment 1700 be interpreted as having any dependency or requirement relating to any one or combination of components illustrated in the exemplary operating environment 1700.

Embodiments are operational with numerous other general purpose or special purpose computing system environments or configurations. Examples of well-known computing systems, environments, and/or configurations that may be suitable for use with various embodiments include, but are not limited to, embedded computing systems, personal computers, server computers, hand-held or laptop devices, smart phones, smart cameras, tablets, multiprocessor systems, microprocessor-based systems, set top boxes, programmable consumer electronics, network PCs, minicomputers, mainframe computers, cloud services, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 17, an example system for implementing some embodiments includes a general-purpose computing device in the form of a computer 1710. Components of computer 1710 may include, but are not limited to, a processing unit 1720, a system memory 1730, and a system bus 1721 that couples various system components including the system memory to the processing unit 1720.

Computer 1710 typically includes a variety of computer readable media. Computer readable media can be any available media that can be accessed by computer 1710 and includes both volatile and nonvolatile media, and removable and non-removable media. By way of example, and not limitation, computer readable media may comprise computer storage media and communication media. Computer storage media includes both volatile and nonvolatile, and removable and non-removable media implemented in any method or technology for storage of information such as computer readable instructions, data structures, program modules or other data. Computer storage media includes, but is not limited to, random access memory (RAM), read-only memory (ROM), electrically erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by computer 1710. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above should also be included within the scope of computer readable media.

The system memory 1730 includes computer storage media in the form of volatile and/or nonvolatile memory such as ROM 1731 and RAM 1732. A basic input/output system 1733 (BIOS), containing the basic routines that help to transfer information between elements within computer 1710, such as during start-up, is typically stored in ROM 1731. RAM 1732 typically contains data and/or program modules that are immediately accessible to and/or presently being operated on by processing unit 1720. By way of example, and not limitation, FIG. 17 illustrates operating system 1734, application programs 1735, other program modules 1736, and program data 1737.

The computer 1710 may also include other removable/non-removable volatile/nonvolatile computer storage media. By way of example only, FIG. 17 illustrates a hard disk drive 1741 that reads from or writes to non-removable, nonvolatile magnetic media, a magnetic disk drive 1751 that reads from or writes to a removable, nonvolatile magnetic disk 1752, a flash drive reader 1757 that reads flash drive 1758, and an optical disk drive 1755 that reads from or writes to a removable, nonvolatile optical disk 1756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1741 is typically connected to the system bus 1721 through a non-removable memory interface such as interface 1740, and magnetic disk drive 1751 and optical disk drive 1755 are typically connected to the system bus 1721 by a removable memory interface, such as interface 1750.

The drives and their associated computer storage media discussed above and illustrated in FIG. 17 provide storage of computer readable instructions, data structures, program modules and other data for the computer 1710. In FIG. 17, for example, hard disk drive 1741 is illustrated as storing operating system 1744, application programs 1745, program data 1747, and other program modules 1746. Additionally, for example, non-volatile memory may include instructions to, for example, discover and configure IT device(s); the creation of device neutral user interface command(s); combinations thereof, and/or the like.

Commands and information may be entered into the computing hardware 1710 through input devices such as a keyboard 1762, a microphone 1763, a camera 1764, imaging sensor 1766 (e.g., 1520, 1492, and 1340) and a pointing device 1761, such as a mouse, trackball or touch pad. These and other input devices are often connected to the processing unit 1720 through an input interface 1760 that is coupled to the system bus, but may be connected by other interface and bus structures, such as a parallel port, game port or a universal serial bus (USB). A monitor 1791 or other type of display device may also be connected to the system bus 1721 via an interface, such as a video interface 1790. Other devices, such as, for example, speakers 1797, printer 1796 and network switch(es) 1798 may be connected to the system via peripheral interface 1795.

The computer 1710 is operated in a networked environment using logical connections to one or more remote computers, such as a remote computer 1780. The remote computer 1780 may be a personal computer, a hand-held device, a server, a router, a network PC, a peer device or other common network node, and typically includes many or all of the elements described above relative to the computer 1710. The logical connections depicted in FIG. 17 include a local area network (LAN) 1771 and a wide area network (WAN) 1773, but may also include other networks. Such networking environments are commonplace in offices, enterprise-wide computer networks, intranets and the Internet.

When used in a LAN networking environment, the computer 1710 is connected to the LAN 1771 through a network interface or adapter 1770. When used in a WAN networking environment, the computer 1710 typically includes a modem 1772 or other means for establishing communications over the WAN 1773, such as the Internet. The modem 1772, which may be internal or external, may be connected to the system bus 1721 via the user input interface 1760, or other appropriate mechanism. The modem 1772 may be wired or wireless. Examples of wireless devices may comprise, but are limited to: Wi-Fi and Bluetooth. In a networked environment, program modules depicted relative to the computer 1710, or portions thereof, may be stored in the remote memory storage device. By way of example, and not limitation, FIG. 17 illustrates remote application programs 1785 as residing on remote computer 1780. It will be appreciated that the network connections shown are exemplary and other means of establishing a communications link between the computers may be used. Additionally, for example, LAN 1771 and WAN 1773 may provide a network interface to communicate with other distributed infrastructure management device(s); with IT device(s); with users remotely accessing the User Input Interface 1760; combinations thereof, and/or the like.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

In this specification, “a” and “an” and similar phrases are to be interpreted as “at least one” and “one or more.” References to “an” embodiment in this disclosure are not necessarily to the same embodiment.

Many of the elements described in the disclosed embodiments may be implemented as modules. A module is defined here as an isolatable element that performs a defined function and has a defined interface to other elements. The modules described in this disclosure may be implemented in hardware, a combination of hardware and software, firmware, wetware (i.e. hardware with a biological element) or a combination thereof, all of which are behaviorally equivalent. For example, modules may be implemented using computer hardware in combination with software routine(s) written in a computer language (e.g., C, C++, FORTRAN, Java, Basic, Matlab or the like) or a modeling/simulation program (e.g., Simulink, Stateflow, GNU Octave, or LabVIEW MathScript). Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies may be used in combination to achieve the result of a functional module.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, some of the above explanation has focused on the example of an embodiment where the personal warning device may be employed as a personal warning device worn on a user's back. However, one skilled in the art will recognize that embodiments of the invention could be employed in other areas such as, but not limited to: building security, automated driving, monitoring races, motion capture, combinations thereof, and/or the like.

In addition, it should be understood that any figures that highlight any functionality and/or advantages, are presented for example purposes only. The disclosed architecture is sufficiently flexible and configurable, such that it may be utilized in ways other than those shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112. Claims that do not expressly include the phrase “means for” or “step for” are not to be interpreted under 35 U.S.C. 112.

1. An apparatus, comprising:
a. at least one imaging sensor configured to acquire at least one set of spatiotemporal measurements from at least two sensing zones;
b. at least one multifocal lens configured to direct electromagnetic radiation from at least two of a multitude of spatial zones to at least two of the sensing zones respectively;
c. a focus analyzer configured to process each of the at least one set to determine an in-focus status of the at least two sensing zones; and
d. a displacement processor configured to generate at least one object displacement vector, based at least in part, on a sequence of focus status indicative of an object moving between at least two of the multitude of spatial zones.

2. The apparatus according to claim 1, wherein the imaging sensor is at least one of the following:
a. an infrared imaging sensor;
b. an ultraviolet imaging sensor;
c. an optical imaging sensor;
d. a camera;
e. an electromagnetic imaging sensor;
f. a light field device; and
g. an array of imaging sensors.

3. The apparatus according to claim 1, wherein the electromagnetic radiation comprises visual spectrum radiation.

4. The apparatus according to claim 1, wherein each of at least two of the spatial focus zones is azimuth, elevation and depth of field limited.

5. The apparatus according to claim 1, wherein at least one of the spatial zones is a beam comprising an instantaneous field of view and a constrained depth of field.

6. The apparatus according to claim 1, wherein at least one of the sensing zones comprises a subset of pixels on the imaging sensor.

7. The apparatus according to claim 1, wherein the focus analyzer is further configured to determine the in-focus status by applying at least one range based point spread function to at least one of the at least one set of spatiotemporal measurements.

8. The apparatus according to claim 1, wherein the focus analyzer is further configured to determine at least one focus status by performing a sharpness analysis on at least one of the sensing zones.

9. The apparatus according to claim 1, wherein the focus analyzer is further configured to determine at least one focus status by performing a frequency analysis on at least one of the sensing zones.

10. The apparatus according to claim 1, wherein the focus analyzer is further configured to determine at least one focus status by performing a deconvolution of spatiotemporal measurements of at least one of the sensing zones.

11. The apparatus according to claim 1, wherein the displacement processor is further configured to generate the object displacement vector employing sequential analysis.

12. The apparatus according to claim 1, wherein the displacement processor is further configured to set the object displacement vector to a null value when fewer than two of the in-focus statuses each exceed at least one predetermined criterion.

13. The apparatus according to claim 1, wherein the displacement processor is further configured to convert at least two in-focus status into at least one binary valued sequence.

14. The apparatus according to claim 1, wherein the displacement processor is further configured to generate the object displacement vector by comparing at least one binary valued sequence against at least one predetermined binary valued sequence.

15. The apparatus according to claim 1, wherein the displacement processor is further configured to generate the object displacement vector, based at least in part, utilizing a finite state machine.

16. The apparatus according to claim 1, wherein the displacement processor is further configured to generate the object displacement vector by analyzing, at least in part, at least two in-focus status with respect to displacement criteria.

17. The apparatus according to claim 1, further comprising an alert module configured to activate an alert in response to the displacement vector exceeding a predetermined threshold.

18. The apparatus according to claim 1, wherein at least one of the sensing zones comprise a distinct region of the sensor.

19. The apparatus according to claim 1, wherein the multi-focal lens is configured to map light from each of at least two of the spatial zones onto at least two of the sensing zones respectively through a camera lens.

20. The apparatus according to claim 1 wherein the multi-focal lens is configured to map light from each of at least two of the spatial zones onto at least two of the sensing zones respectively through a mobile device camera lens.
